(19) United States
(12) Patent Application Publication
(10) Pub. No.: US 2006/0182580 A1
(43) Pub. Date: Aug. 17, 2006

(54) Truck container transport/storage system and method

(76) Inventor: Lewis H. Petersen, Salt Lake City, UT (US)

Correspondence Address: MARCUS G THEODORE, PC, 466 SOUTH 500 EAST, SALT LAKE CITY, UT, 84102, US

(21) Appl. No.: 11/297,572

(22) Filed: Dec. 8, 2005

Related U.S. Application Data
(60) Provisional application No. 60/636,162, filed on Dec. 15, 2004.

(51) Int. Cl. B60P 1/00

(52) U.S. Cl. 414/538

(57) ABSTRACT

A self loading and unloading truck container system and method, which enable fully loaded containers to be loaded on and off the bed of a truck without employment of fork loaders and cranes, while allowing extended on-site moving and container storage.

### RELATED APPLICATIONS

This application is a continuation-in-part of provisional patent application, Ser. No. 60/636,162 filed Dec. 15, 2004 entitled “Truck Container Transport/Storage System and Method”.

### BACKGROUND OF THE INVENTION

1. Field of Invention

The present invention relates to truck container transport systems. In particular, it relates to a self loading and unloading truck bed and trailer container system and method, which enables fully loaded cargo containers to be loaded on and off the bed of a truck or trailer without employment of fork loaders and cranes, while allowing extended on-site moving and container storage.

2. Description of Related Art

Various truck container transport systems are known. Because of the weight of a loaded cargo container, most require that the cargo container be loaded and unloaded with a separate piece of lifting equipment, such as a forklift or crane. This precludes cargo container usage for short runs, because of the cause and nuisance of requiring separate lifting equipment to also accompany the trucks for loading and unloading.

Other container transport systems usually have a truck or trailer with a bed adapted with lift and tilt modes to transport and load and unload cargo containers, such as Rumell, U.S. Pat. No. 4,026,429, and Smith, U.S. Pat. No. 5,324,160.

Still another transport system uses containers with bottom rollers to roll on and off large containers from a trailer bed; see Rasmussen, U.S. Pat. Nos. 4,690,608 and 4,679,979. The containers are first lifted or rolled onto a trailer bed and transported to an unloading site. During unloading, these trailers are backed and suddenly stopped in repeated stages to employ inertial forces to move the nests of containers relative to the trailer until the nests of containers travel the length of the trailer and drop upon the ground. They are thus used where the contents, such as garbage, of the container are not damaged by rough handling.

Rash et al., U.S. Pub. No. US2005/0053442A1 discloses a container adapted with bottom rails to be removably placed on the track on a trailer bed to roll off the container via dolly wheels attached to the bottom of the container for storage at another location. The Rash et al container includes lift means to assist in loading the container onto the trailer bed before transport.

Yan, U.S. Pub. No. US2005/0169737A1 discloses a detachable platform for mounting on a trailer, which provides a maneuverable platform independently to support containers placed thereon to assist is their loading and unloading via hydraulic jack pumps.

Other conventional truck moving systems require same day truck filling, transport, and unloading.

Cited for general interest is Pinto, U.S. Pat. No. 4,132,326 disclosing a multiple hook-up, movable axle container cargo trailer disclosing a cargo trailer, which can be pulled from either end. Wang et al, US Pub. No. US2004/0201251 and U.S. Pat. No. 6,832,809 disclose a semi-trailer with a combinable and removable cargo container body, which can be removably joined and assembled on the trailer to form a transport container. Preller et al., U.S. Pat. No. 5,082,304 discloses a 20 foot container transporting trailer with a hitch adapted to hitch to and clear the fifth wheel of a tractor.

The present invention described below provides a self-loading and unloading truck or trailer with a bed with a rail track system and ramp adapted to slide on and off cargo containers loaded thereon without the aid of an independent loader. It also allows the drop off of the container for extended filling or storage before on loading for transport.

### SUMMARY OF THE INVENTION

The present invention is designed to utilize standard shipping cargo containers for moving and storage transport on the conventional transport bed of a truck or trailer. It comprises a truck or trailer system with a bed sized to accommodate a shipping cargo container placed thereon. The shipping cargo containers envisioned for use for local transport are typically 20 feet long and 8 feet wide, although other longer or shorter containers may be employed. These 20 foot cargo containers usually have a number of internal tie bars or fastening points to secure therein cargo to prevent shifting during transport. They are weather resistant and provide secure cargo storage for goods placed therein. Ideally they are suited for highway transport of furniture and other lighter weight goods, because the containers themselves weight approximately 4,500 pounds. Heavier foodstuffs and cargo provide a loaded truck, which exceeds most highway load restrictions.

The preferred 20 foot shipping cargo container has at least one coupling attached to its bottom end near the center of one end. This coupling is adapted to secure to a hook or other fastener attached to a cable. Other cargo containers with couplings at both opposite container ends could be used.

The truck or trailer bed of the invention is at least 20 feet long and approximately 9 feet wide to accommodate a 20×8 foot cargo container. Attached to the end of the truck or trailer bed is a hinged loading ramp. A rail track system runs along the lengths of both sides of the truck or trailer bed and ramp to form two parallel continuous rails along which the cargo container slides. The ramp is preferably hinge mounted so that it may be lowered for loading and unloading a container, and then raised and stored against a loaded container on the bed during transport. The ramp may be of a singular piece running the width of the bed, or in two parts provided they align with the ramp rails with those of the truck bed.

The rail track system parallel rails are structured to accommodate a corresponding track or roller system on each side of the bottom of a loading container such that the container can slide along the parallel rails for loading and unloading and not shift or slide off during transport. Mounted to the ramp beyond the end of the truck bed proximate its center between the rails is a pulley so that the cables pull containers from a point beyond the bed. Attached to the other end of the truck or trailer bed proximate the cab are dual power wenches with one having a cable and hook of a length that the cable can wrap around the pulley to attach its hook to corresponding couplings at the end of the container proximate the rear end of the truck bed, and the other adapted to attach to the front end of the cable such that the container may be held from the front and rear during unloading and loading to stabilize the load with one pulling and the other acting as a restraint to prevent the container from sliding down the ramp out of control. The parallel rails are of a height that the cable and pulley can fit under the loaded container and be activated without interference from the bottom of the container.

To load a container, wheels are removably attached to the bottom ends of the front and rear of the container. The truck is then backed up next to the container and its loading ramp lowered such that the rails align with the corresponding track or roller system of the container. A spoon or roller system may be used to assist in this alignment process. At least one wench cable is then unwound and removably attached to the coupling of the container next to the loading ramp. The wench is then activated to pull and drag the container up the ramp onto the truck or trailer bed along the rails until it is secured proximate the cab. The ramp is then lifted up and secured against the container for transport.

To unload a container, the ramp is lowered. The cable from the first wench is then passed around the pulley such that its hook can attach to the container coupling proximate the cab such that when the first wench is activated the container is pulled off the truck or trailer bed in the opposite direction until the cargo container gravity slides off the loading ramp. The second wench cable is also affixed to the end of the container next to the cab and is activated as a restraint to prevent the container from rolling away beyond the point where it is to be unloaded. After the container is positioned onto the ground, the cables are unhooked and the truck driven away leaving the cargo container on the ground for loading, unloading, or storage.

This self loading and unloading truck container system allows 20 foot cargo containers to be used for local moving and storage at a relatively low cost as there is no need to send a crane or forklift for loading and unloading. Containers may be delivered to a site and self loaded by a mover or homeowner over a period of days or months depending upon the user's needs. As the containers may be locked, furniture and goods can be secured therein until the entire container is loaded and ready for transport. The self loading and unloading truck container system thus provides not only an inexpensive moving transport system, but a temporary storage container system to meet the loading needs of a shipper or mover. This allows a user to enjoy the convenience of moving for a month or two by employing the container as temporary storage until all the goods are loaded, transported, and unloaded, instead of in one day. This allows a mover to employ off-peak rate movers, thereby further saving labor costs as well. It also insures that the loaded container is delivered to the new location via a licensed trained driver. Consequently, there is no pressure during a move in having to learn how to operate a vehicle.

The invention thus provides a combination moving and temporary storage method to meet the transport and storage needs of a user.

### BRIEF DESRIPTION OF THE DRAWINGS

FIG. 1 is a perspective view of a preferred trailer of the invention.

FIG. 2 is a side view of the trailer shown in FIG. 1.

FIG. 3 is a top view of the trailer shown in FIGS. 1 and 2.

FIG. 4 is transparent view of a loaded cargo container on the trailer shown in FIGS. 1, 2, and 3.

FIG. 5 is a side view of a loaded cargo container on the trailer shown in FIG. 4.

FIG. 6 is a perspective view of a loaded cargo container on the trailer shown in FIG. 4 shown in FIGS. 4 and 5.

FIG. 7 is a side view of a truck with a loaded cargo container on its straight bed.

FIG. 8 is side view of the truck of FIG. 7 showing the cargo container starting to be unloaded.

FIG. 9 is a side view of the truck of FIG. 7 showing the cargo container unloaded.

FIG. 10 is a front view of a preferred container wheel assembly.

FIG. 11 is a perspective view of the wheel assembly 41 shown in FIG. 10.

FIG. 12 is a side view of the wheel assembly 41 shown in FIG. 10.

FIG. 13 is a side view of a preferred trailer extender.

FIG. 14 is a perspective view of the trailer extender shown in FIG. 13.

FIG. 15 is a front view of the trailer extender shown in FIG. 14.

FIG. 16 is a perspective view of a preferred tailgate bridge assembly.

FIG. 17 is a side view of the tailgate bridge assembly shown in FIG. 16.

### DESCRIPTION OF THE ILLUSTRATED EMBODIMENTS

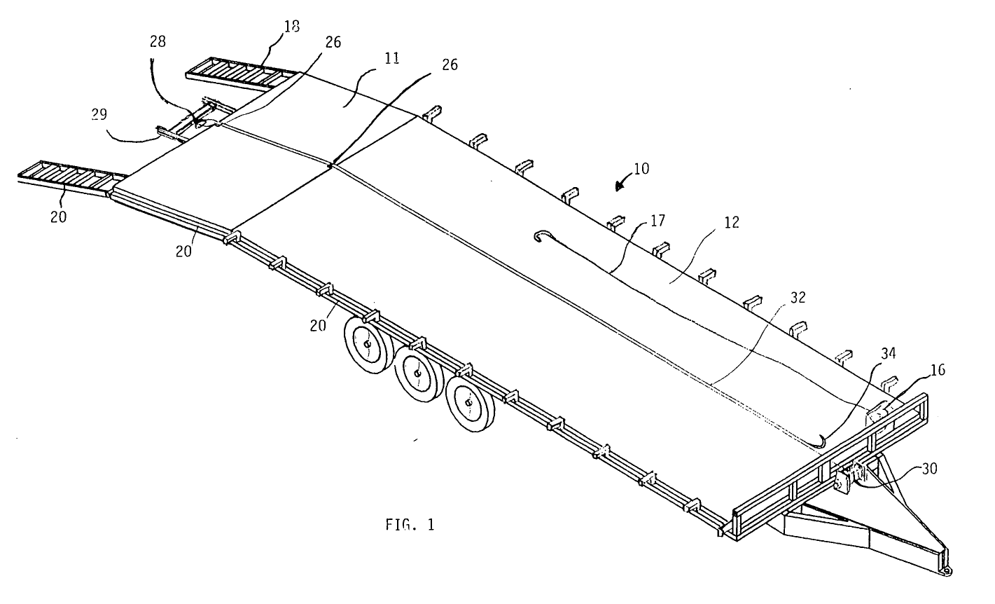

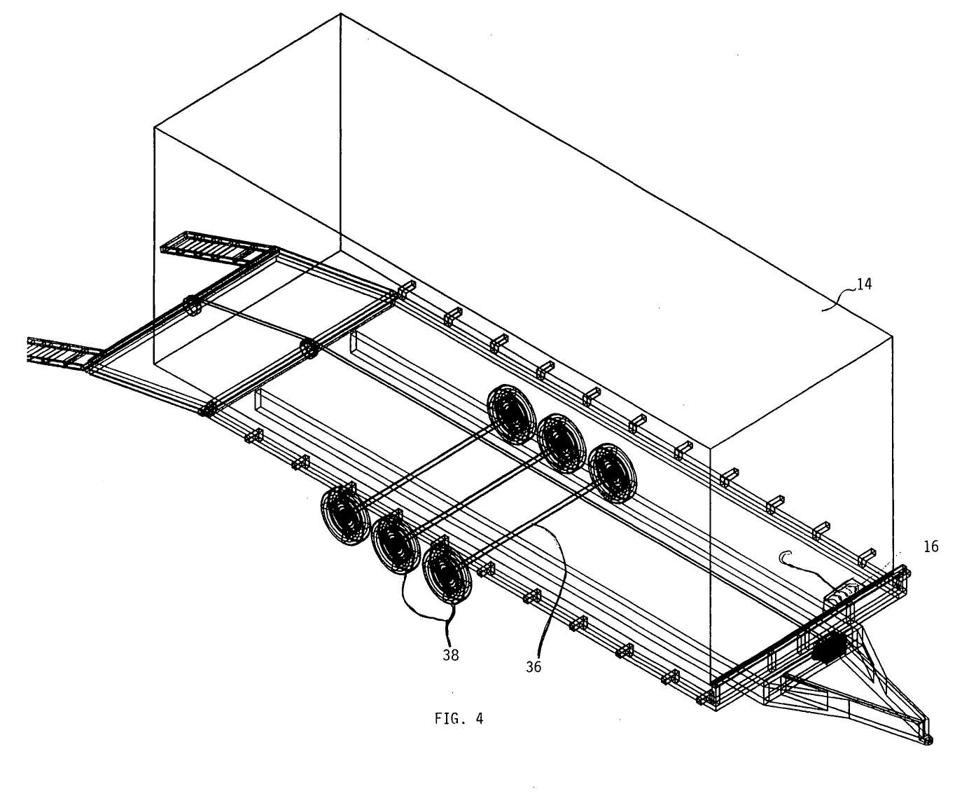

FIG. 1 is a perspective view of a preferred trailer 10 of the invention with an angled rear segment 11 of its bed 12 to aid in sliding containers on and off the bed 12. The trailer 10 bed 12 of the invention is at least 20 feet long and approximately 9 feet wide to accommodate a 20×8 foot cargo container 14 shown in FIG. 5. Attached to the end of the trailer bed 12 proximate the cab is a first hydraulic wench 16 with cable and hook 17. Attached to the end of the trailer bed 12 opposite the truck cab are ramps 18 hinged to the loading ramp segment 16 to contact the ground, when lowered, and to secure against a loaded container 14, when raised.

A rail track system of parallel continuous rails 20 runs along the lengths of both sides of the trailer bed 12 and ramp extensions 18 to form two parallel continuous rails 20 along which the cargo container 14 slides.

The rail track parallel rails 20 are structured to accommodate corresponding removable wheels 24 shown in FIG. 5 placed on each corner of the bottom of a loading container 14 such that the container 14 can slide and roll along the parallel rails 20 for loading and unloading and not shift or slide off during transport.

Mounted to the end of the trailer bed 12 proximate its center between the rails is a cable guide 26. A pulley 28 is mounted to the end of an angled loading ramp extension 29 removably affixed to the end of the trailer bed 12. Attached to the other end of the trailer bed 12 proximate the cab is a second power wench 30 with a cable 32 and hook 34. The cable 32 is of a length such that the cable can wrap around the pulley 28 to attach its hook 34 to corresponding couplings (not shown) on either end of the container 14. The parallel rails 20 are of a height such that the cables 17, 32 and hooks 34 can fit under the loaded container 14 and be activated without interference from the bottom of the container 14.

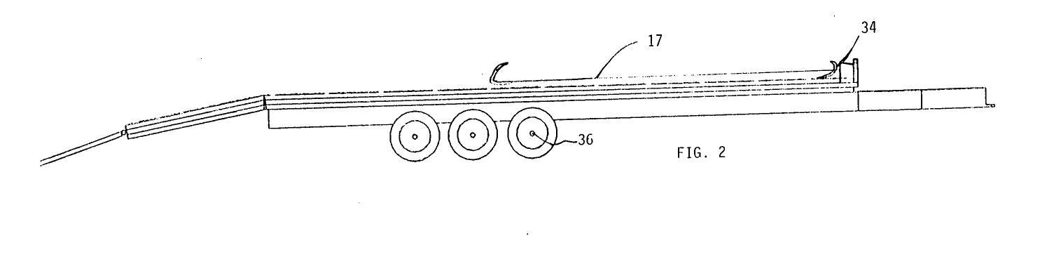

FIG. 2 is a side view of the trailer 10 shown in FIG. 1. The trailer has triple axles 36 shown in FIG. 4 with six wheels 38.

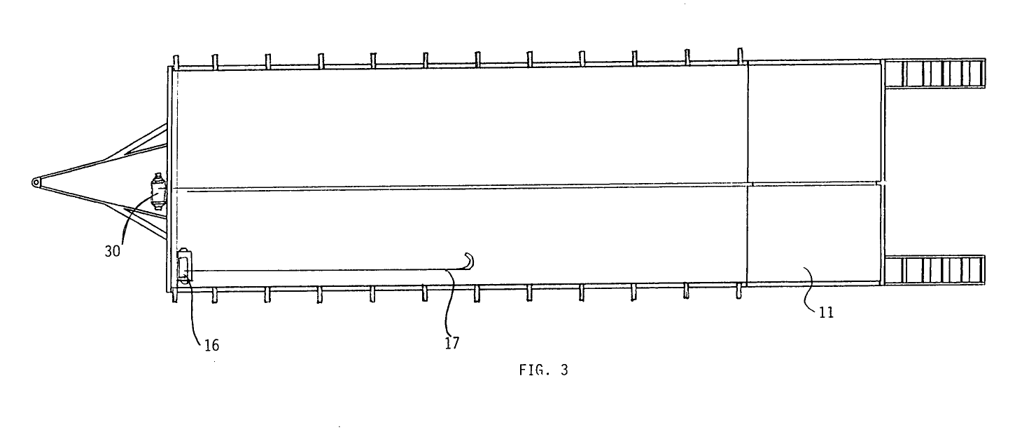

FIG. 3 is a top view of the trailer 10 shown in FIGS. 1 and 2.

FIG. 4 is transparent view of a loaded cargo container 14 on the trailer bed 12 shown in FIGS. 1, 2, and 3.

FIG. 5 is a side view of a loaded cargo container 14 on the trailer 10 shown in FIG. 4.

FIG. 6 is a perspective view of a loaded cargo container 14 on the trailer 10 shown in FIGS. 4 and 5.

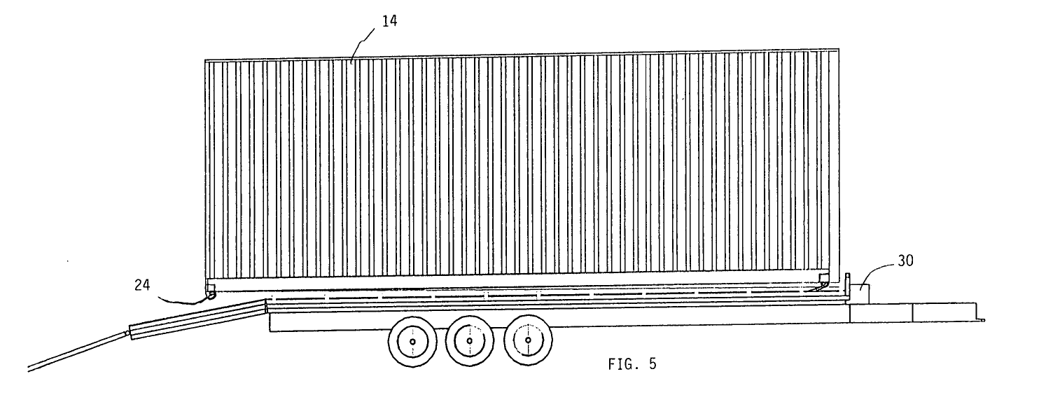

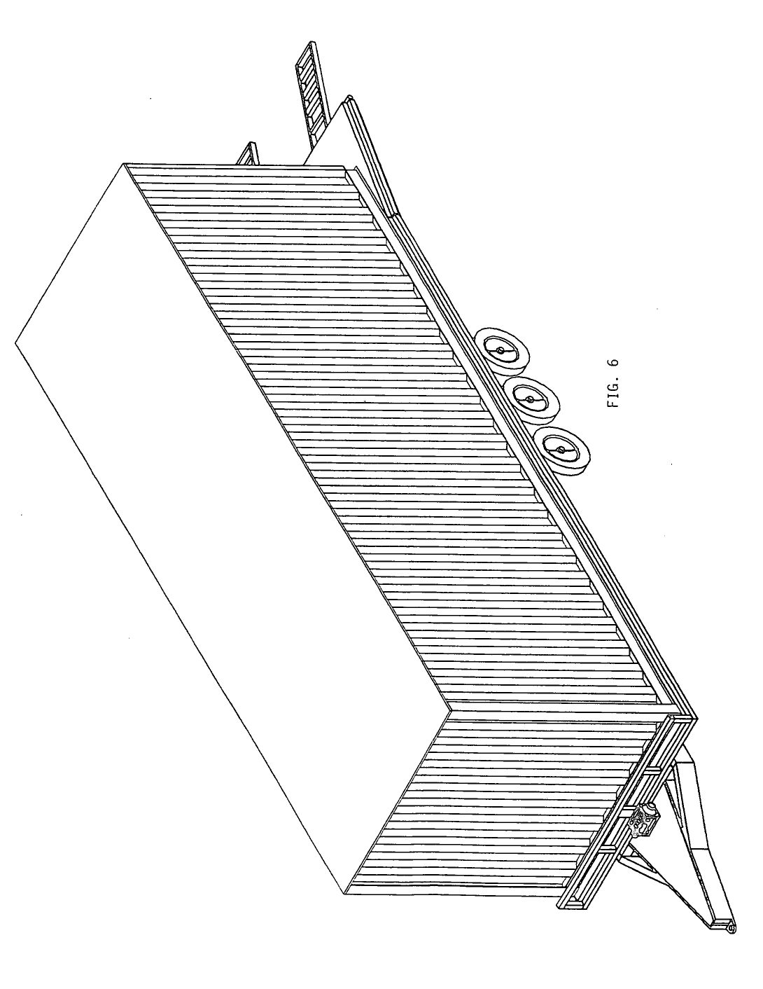

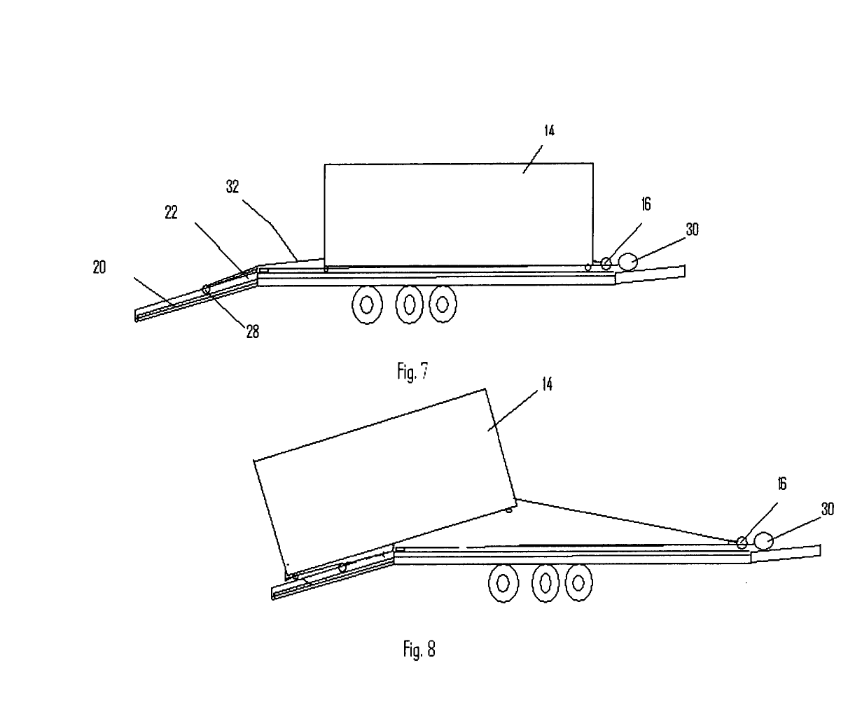

FIG. 7 is a side view of a trailer 10 with a loaded cargo container 14 on its straight bed 12. Its ramp 22 is preferably hinge mounted so that it may be lowered for loading and unloading a container 14, and then raised and stored against a loaded container on the bed 12 during transport. The ramp 22 may be of a singular piece running the width of the bed, or in two parts as shown in FIG. 1, provided they align with the ramp rails 22 with those of the truck bed 12. The trailer 10 employs wenches 16, 30, cables 17, 32, and the hook system described above with a rear pulley 28 attached to the end of the truck bed extension 29 described above to load and unload cargo containers 14.

FIG. 8 is side view of the trailer of FIG. 7 showing the cargo container 14 pulled by wench 30 and restrained by wench 16 as it is unloaded until it pivots over the edge of the truck bed 12 and thereafter gravity unloaded as the container 14 then slides down the ramps 22 via its own weight.

FIG. 9 is a side view of the trailer of FIG. 7 showing the cargo container 14 unloaded and ready for emptying or loading or storage.

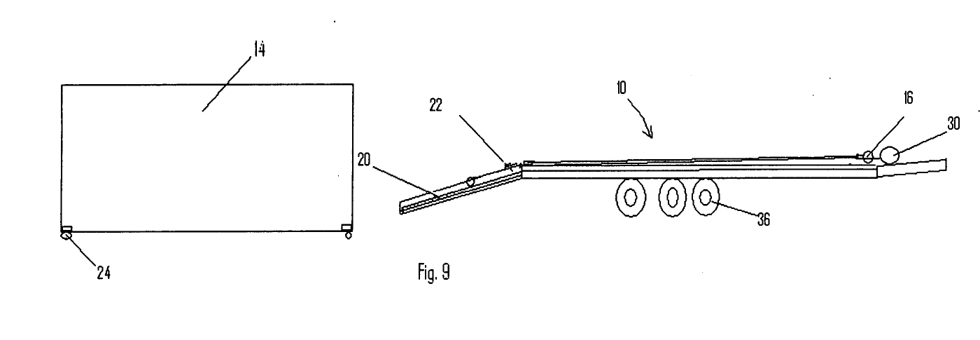

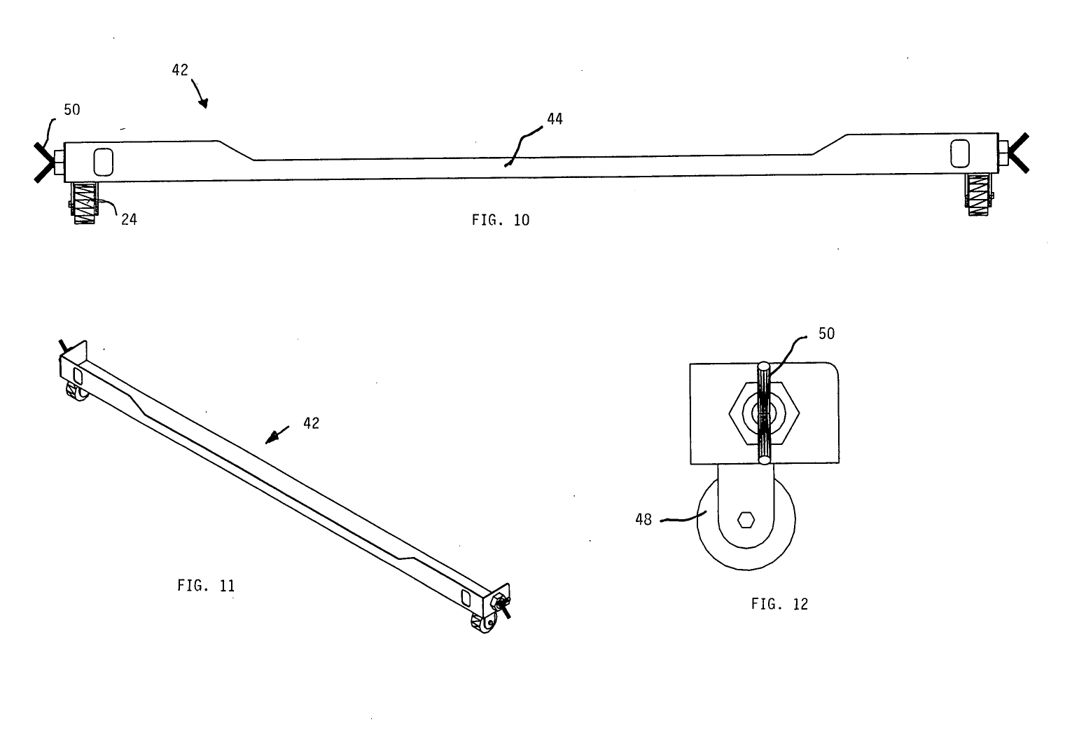

FIG. 10 is a front view of a preferred container wheel assembly 42 containing a removable support 44, which is removably attached to the front and back under edges of the container 14 to be moved. The support 44 has a pair of wheels 24 at each end and is affixed to the bottom of the container 14 via wing nuts 50 and bolts which pass through holes in the bottom edges of a standard shipping container to align and removably secure the wheels 24 thereto.

FIG. 11 is a perspective view of the wheel assembly 42 shown in FIG. 10.

FIG. 12 is a side view of the wheel assembly 42 shown in FIG. 10 showing the locking nut 50, which removably secures the wheel assembly 42 to the lower edges of either end of the container 14.

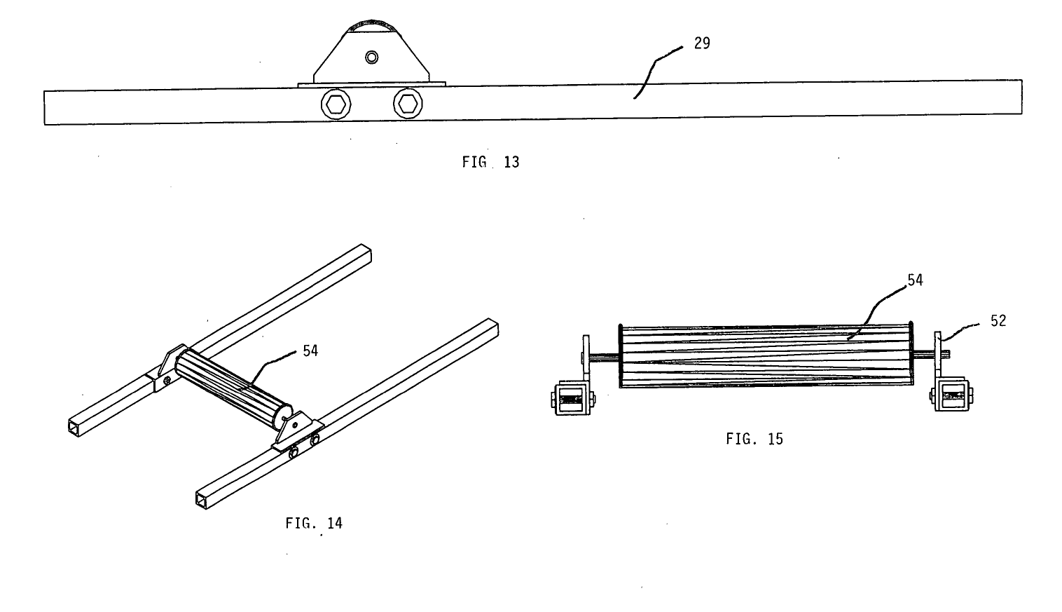

FIG. 13 is a side view of a trailer extender 29 with a roller 54 instead of the pulley 28, which removably fits within a trailer hitch (not shown) on the back of the trailer 10 so that an extended lower angle pull is provided to the rear of the container 14 to better leverage the container off the trailer bed 12. FIG. 14 is a perspective view of the trailer extender 29 shown in FIG. 13. FIG. 15 is a front view of the trailer extender 29 shown in FIG. 14.

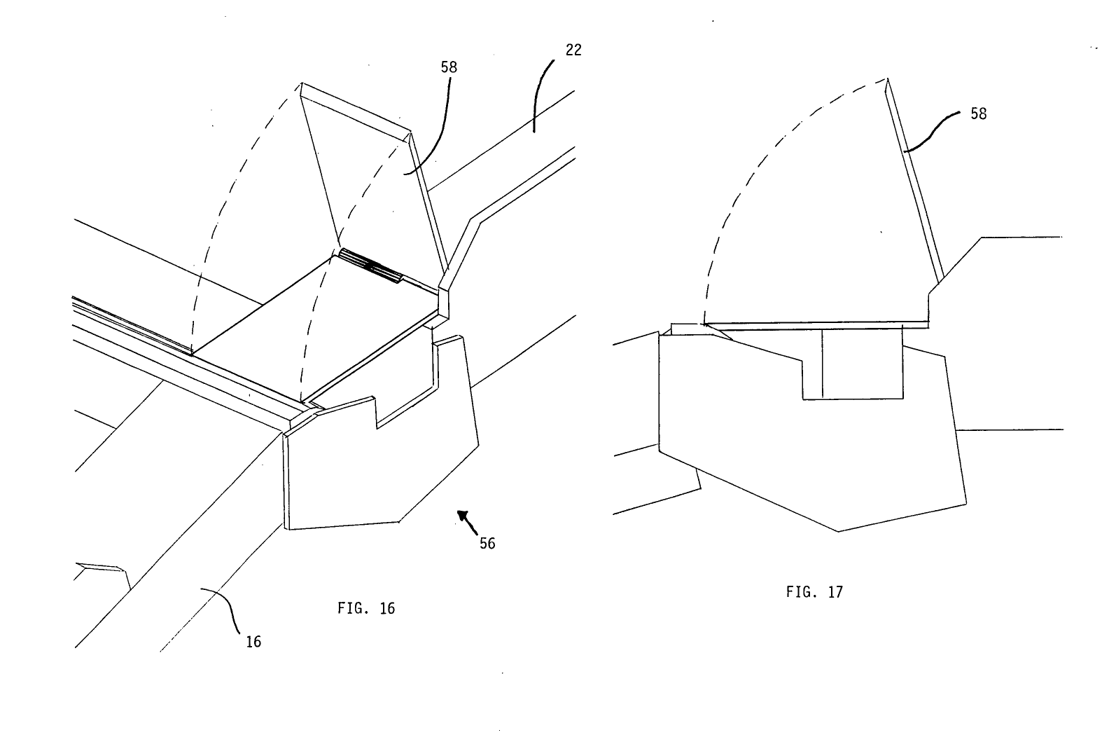

FIG. 16 is a perspective view of a tailgate bridge assembly 56 showing how a liftable flap 58 is lowered to bridge the gap of the rails 22 of a hingedly lowered ramp 16. This flap 58 is adapted so that the wheels 24 of the trailer wheel assembly 42 slide smoothly along the rails 22 to minimize drag resistance. FIG. 17 is a side view of the tailgate bridge assembly 56 show in FIG. 16.

The above description and specification should not be construed as limiting the scope of the claims but as merely providing illustrations of some of the presently preferred embodiments of this invention. The claims themselves recite those features deemed essential to the invention.

I claim:

1. A truck or trailer container storage/transport system for trucks and trailers with a transport bed sized to accommodate shipping cargo containers having at least one container coupling attached to their bottom ends comprising:
a. a plurality of wheels removably attached to the bottoms of the cargo containers to be used for transport and storage,
b. a hinged ramp affixed to the back of the transport bed to drop down in one mode to allow a container to slide off and onto the transport bed for loading and unloading, and fold up against a container slid onto the bed in a second mode for transport,
c. a rail track system affixed to the transport bed and hinged ramp to align the travel of the cargo container wheels as containers are slide along the bed and ramp,
d. a cable pulley extension affixed to the rear of the trailer beyond the end of the transport bed, and
e. dual first and second opposing wenches affixed to the truck and/or trailer bed with cables having ends adapted to removably secure to the container couplings, the first wench having a cable of a length to extend and wrap around the cable pulley extension to removably attach to one of the back cargo container couplings nearest the cab; the second wench cable of a length to extend the length of the bed and ramp and attaches to the cargo container coupling next to the truck cab; whereby in the unloading mode both of said wenches affixed to the container proximate the cab are selectively activated for the first wench cable to pull the container down the ramp, and the other to restrain the cargo container as it is lowered down the bed and ramp to prevent it from rolling away as the container is unloaded from the transport bed for storage and loading/unloading; and in the loading mode at least one of the wenches is attached to the container coupling next to the ramp to pull the container up onto the bed for transport; and in the storage mode the cables are removed from the container after being placed in position allowing the truck or trailer to drive off.

2. A truck or trailer container storage/transport system according to claim 1, wherein in the unloading mode the first wench pulls the loaded container along the bed and down the ramp until the weight of the container and its contents causes the container to gravity slide off the trailer bed onto the ground and the second wench acts as a restraint to prevent the loaded container from rolling away before being positioned for storage.

3. A truck or trailer container storage/transport system according to claim 1, wherein the cable ends comprise a hook or other removable attachment fastener.

4. A truck or trailer container storage/transport system according to claim 1, wherein the rail track system runs along the lengths of both sides of the truck or trailer bed and ramp to form two parallel continuous rails along which the cargo container slides.

6. A truck or trailer container storage/transport system according to claim 1, wherein the ramp is either a singular piece running the width of the bed, or in two parts which align with the ramp rails of the truck bed.

7. A truck or trailer container storage/transport system according to claim 6, wherein the parallel rails are of a height such that the cables can fit under the loaded container and be activated without interference from the bottom of the container.

8. A truck or trailer container storage/transport system for trucks and trailers with a transport bed sized to accommodate shipping cargo containers having at least one container coupling attached to their bottom ends comprising:
a. a plurality of wheels removably attached to the bottoms of the cargo containers to be used for transport and storage,
b. a hinged ramp is either a singular piece running the width of the bed, or in two parts which align with the ramp rails of the truck bed affixed to the back of the transport bed having a cable pulley extension positioned beyond the end of the transport bed to drop down in one mode to allow a container to slide off and on the bed for loading and unloading, and fold up against a container slid onto the bed in a second mode for transport,
c. a rail track system comprised of two parallel continuous rails running along the lengths of both sides of the truck or trailer bed and ramp to align the travel of the cargo container wheels as containers are slide along the bed and ramp, having a height such that the cables can fit under the loaded container and be activated without interference from the bottom of the container,
d. a cable pulley extension affixed to the rear of the trailer beyond the end of the transport bed, and
e. dual first and second opposing wenches affixed to the truck and/or trailer bed with cables having ends adapted as a hook or other fastener to removably secure to either end of the container couplings, the first wench having a cable of a length to extend and wrap around the cable pulley extension to removably attach to a cargo container couplings nearest the cab; the second wench cable having a length to extend the length of the bed and ramp and attaches to a cargo container coupling next to the truck cab; whereby in the unloading mode the cables of both of said wenches are removably affixed to the container proximate the cab and are selectively activated for the first wench cable to pull the container down the trailer bed and ramp, and the other cable to restrain the cargo container as it is lowered down the bed and ramp to prevent it from rolling away as the container is unloaded from the transport bed for storage and loading/unloading; and in the loading mode at least one of the wenches is attached to the container coupling next to the ramp to pull the container up onto the bed for transport; and in the storage mode the cables are removed from the container positioned on the ground allowing the truck or trailer to drive off.

9. A truck or trailer container storage/transport system according to claim 8, wherein in the unloading mode the first wench pulls the loaded container along the bed and down the ramp until the weight of the container and its contents gravity slide the container off the trailer bed onto the ground and the second wench acts as a restraint to prevent the loaded container from rolling away before being slid onto and placed on the ground for storage.

10. A truck or trailer container storage/transport system according to claim 9, wherein in the loading mode the first wench cable is attached to the end of the cargo container opposite the truck cab as a restraint while the second wench cable attached to the opposite end of the container pulls the cargo container onto the transport bed to prevent the container from tipping abruptly onto the transport bed as the cargo container end pivots onto the transport bed.

11. A truck or trailer container storage/transport method for trucks and trailers with a transport bed sized to accommodate shipping cargo containers having at least one container coupling attached to their bottom ends comprising:
a. attaching removably a plurality of wheels to the bottoms of the cargo containers to be used for transport and storage,
b. affixing a hinged ramp to the back of the transport bed having a cable pulley extension beyond the end of the transport bed to drop down in one mode to allow a container to slide off and on the transport bed for loading and unloading, and fold up against a container slid onto the transport bed in a second mode for transport,
c. affixing a rail track system to the transport bed and hinged ramp to align the travel of the cargo container wheels as containers are slide along the bed and ramp,
d. affixing dual first and second opposing wenches to the truck and/or trailer bed with cables having ends adapted to removably secure to the container couplings, the first wench having a cable of a length to extend and wrap around the cable pulley extension to removably attach to one of the cargo container couplings nearest the truck cab; the second wench cable has a length to extend the length of the bed and ramp and attaches to the cargo container coupling next to the truck cab, whereby in the unloading mode the cables of both of said wenches are removably affixed to the container proximate the cab and are selectively activated for the first wench cable to pull the container down the trailer bed and ramp, and the other cable to restrain the cargo container as it is lowered down the bed and ramp to prevent it from rolling away as the container is unloaded from the transport bed for storage and loading/unloading; and in the loading mode at least one of the wenches is attached to the container coupling next to the ramp to pull the container up onto the bed for transport; and in the storage mode the cables are removed from the container positioned on the ground allowing the truck or trailer to drive off, and
e. selectively activating both wenches in the unloading mode for the first wench cable to pull and the second wench to maintain tension on the cargo container as it is lowered down the bed and ramp to prevent the container from rolling out of control as it is unloaded from the transport bed for storage and unloading; in the loading mode at least one of the wenches is activated to pull the container up the ramp onto the transport bed for transport; and in the storage mode neither wench is activated.

12. A truck or trailer container storage/transport method according to claim 11, wherein
a. in the unloading mode the first wench pulls the loaded container along the bed and down the ramp until the weight of the container and its contents gravity slide the container off the trailer bed onto the ground and the second wench acting as a restraint to prevent the loaded container from rolling away before being slid onto and placed on the ground for storage; and
b. in the loading mode positioning the truck or trailer with its ramp lowered against the ground proximate the cargo container and re-attaching the second wench cable to the cargo container couplings proximate the ramp and the first wench cable to the opposite end of the cargo container such that the second wench drags the container up the ramp and onto the transport bed for transport and the first wench cable acts as a restraint to prevent the container from abruptly tipping onto the transport bed.

13. A truck or trailer container storage/transport method according to claim 11, wherein the cable ends comprise a hook or other fastener adapted to removably attach to the container couplings.

14. A truck or trailer container storage/transport method according to claim 11, wherein the rail track system runs along the lengths of both sides of the truck or trailer bed and ramp to form two parallel continuous rails along which the cargo container slides.

15. A truck or trailer container storage/transport method according to claim 11, wherein the ramp is either a singular piece running the width of the bed, or in two parts which align with the ramp rails of the truck bed.

16. A truck or trailer container storage/transport system according to claim 16, wherein the parallel rails are of a height such that the cables can fit under the loaded container and be activated without interference from the bottom of the container.
